(19) United States
(12) Patent Application Publication
(10) Pub. No.: US 2026/0089819 A1
(43) Pub. Date: Mar. 26, 2026

(54) TEMPORAL LIGHT ARTIFACT-FREE DIMMING CONTROL FOR LIGHTING SOURCES

(71) Applicant: RENSSELAER POLYTECHNIC INSTITUTE, Troy, NY (US)

(72) Inventor: Andrew Carl Bierman, Albany, NY (US)

(73) Assignee: RENSSELAER POLYTECHNIC INSTITUTE, Troy, NY (US)

(21) Appl. No.: 19/111,023

(22) PCT Filed: Sep. 13, 2023
(86) PCT No.: PCT/US2023/032599

§ 371 Date: Mar. 12, 2025

Related U.S. Application Data
(60) Provisional application No. 63/405,909, filed on Sep. 13, 2022.

(51) Int. Cl. H05B 45/14; H05B 45/59

(52) U.S. Cl. CPC H05B 45/14; H05B 45/59

(57) ABSTRACT

Systems and methods for reducing temporal light artifacts (“TLAs”) occurrence during light source dimming operations are provided. The system includes a dimmer, a light source, and a driving circuit. The driving circuit is configured to receive a signal from the dimmer and perform a dimming curve algorithm on the signal to drive the light source with a non-linear dimming curve such that a light output of the light source over a dimming duration has no TLAs detectable by a human observing the light output. The method includes receiving, at a driving circuit, a signal from a dimmer; performing a dimming curve algorithm on the signal to generate a non-linear dimming curve; and driving a light source with the non¬linear dimming curve to dim a light output of the light source such that the light output over a dimming duration has no TLAs detectable by a human observing the light output.

### CROSS REFERENCE TO RELATED APPLICATIONS

This application claims the priority benefit of U.S. Provisional Patent Application No. 63/405,909, filed Sep. 13, 2022, which is incorporated by reference as if disclosed herein in its entirety.

### FIELD

The present technology relates generally to the field of lighting sources, and more particularly, to dimming control for light-emitting diode (“LED”) light sources.

### BACKGROUND

Recent advances in electronic drivers for solid-state light sources (e.g., LEDs) have enabled lighting suppliers to offer products with adjustable light output that can be dimmed to much less than 1% of full output with precise control. As dimming range is extended to lower and lower limits, precise control of light output becomes more critical to meet customer expectations that dimming should appear smooth and predictable over all levels. Human brightness perception is not linear with light output, but rather perceived differences in light output are relative to the prior light level. Roughly, the percentage change leading to a detectable difference remains constant. Therefore, at 1% dim level, human sensitivity to changing light level is 100 times greater than at full light output.

In addition to steady-state brightness perception, sensitivity to temporal changes in light level varies greatly depending on the frequency of the change. Maximum sensitivity to temporal light output changes (i.e., flicker) occurs at frequencies between 10 and 20 Hz where people can detect modulation in light output as light as 0.5%. Sensitivity decreases slightly for lower frequencies and decreases rapidly for higher frequencies. Somewhere between 5 Hz and 1 Hz the sensation of annoying flicker changes to an acceptable observance of light output change. Flicker, defined as the perception of rapid variations in light output, is an undesirable light source characteristic that manufacturers strive to eliminate from their products. Even when light output changes are intentional, as with dimming, how those changes are physically realized often leads to flicker perceptions that are recently described as temporal light artifacts (“TLAs”). However, current dimming curves have been unable to sufficiently minimize, or even eliminate, TLAs while maintaining sufficient transition times.

What is needed, therefore, is an improved system and method of light dimming control that addresses at least the problems described above.

### SUMMARY

According to an embodiment of the present technology, a system for reducing temporal light artifacts (“TLAs”) occurrence during light source dimming operations is provided. The system includes a dimmer, a light source, and a driving circuit. The driving circuit is configured to receive a signal from the dimmer and perform a dimming curve algorithm on the signal to drive the light source with a non-linear dimming curve such that a light output of the light source over a dimming duration has no TLAs detectable by a human observing the light output.

In some embodiments, the non-linear dimming curve has an irregular transition at a starting point of the curve and a smooth transition at an ending point of the curve. In some embodiments, the non-linear dimming curve is an exponential curve, and the dimming duration is about 1 second or less. In other embodiments, the non-linear dimming curve is a cycloid curve, and the dimming duration is about 1 second or less.

In some embodiments, the non-linear dimming curve has a smooth transition at a starting point of the curve and a smooth transition at an ending point of the curve. In some embodiments, the non-linear dimming curve is a cosine curve, and the dimming duration is about 1 second or less.

In some embodiments, performing the dimming curve algorithm includes determining a maximum rate of change of the dimming curve based, at least in part, on a modulation threshold of the signal; determining a relative rate of change of the dimming curve based, at least in part, on a minimum dim level of the light source; determining a minimal detectable rate of change based, at least in part, on the maximum rate of change and the relative rate of change of the dimming curve; and calculating an instantaneous rate of change of the dimming curve at an ending point of the curve such that the instantaneous rate of change is less than the minimal detectable rate of change. In some embodiments, calculating the instantaneous rate of change includes solving the W₋₁ branch of a Lambert W function equation.

In some embodiments, the driving circuit includes a rectifier, a voltage sensor, a voltage-to-frequency converter, and a power supply modulator. The rectifier is configured to rectify the signal received from the dimmer. The voltage sensor is configured to receive a rectified signal from the rectifier and to detect a voltage of the rectified signal. The voltage-to-frequency converter is configured to receive a rectified voltage from the voltage sensor and to convert the rectified voltage to a rectified frequency. The power supply modulator is configured to receive the rectified frequency from the voltage-to-frequency converter and perform the dimming curve algorithm to drive the light source with the non-linear dimming curve.

In some embodiments, the light source is a light-emitting diode (“LED”) light source.

According to another embodiment of the present technology, a method for reducing temporal light artifacts (“TLAs”) occurrence during light source dimming operations is provided. The method includes receiving, at a driving circuit, a signal from a dimmer; performing a dimming curve algorithm on the signal to generate a non-linear dimming curve; and driving, via the driving circuit, a light source with the non-linear dimming curve to dim a light output of the light source such that the light output over a dimming duration has no TLAs detectable by a human observing the light output.

In some embodiments, the non-linear dimming curve has an irregular transition at a starting point of the curve and a smooth transition at an ending point of the curve. In some embodiments, the non-linear dimming curve is an exponential curve, and the dimming duration is about 1 second or less. In other embodiments, the non-linear dimming curve is a cycloid curve, and the dimming duration is about 1 second or less.

In some embodiments, the non-linear dimming curve has a smooth transition at a starting point of the curve and a smooth transition at an ending point of the curve. In some embodiments, the non-linear dimming curve is a cosine curve, and the dimming duration is about 1 second or less.

In some embodiments, performing the dimming curve algorithm includes determining a maximum rate of change of the dimming curve based, at least in part, on a modulation threshold of the signal; determining a relative rate of change of the dimming curve based, at least in part, on a minimum dim level of the light source; determining a minimal detectable rate of change based, at least in part, on the maximum rate of change and the relative rate of change of the dimming curve; and calculating an instantaneous rate of change of the dimming curve at an ending point of the curve such that the instantaneous rate of change is less than the minimal detectable rate of change. In some embodiments, calculating the instantaneous rate of change includes solving the W₋₁ branch of a Lambert W function equation.

In some embodiments, the driving circuit includes a rectifier, a voltage sensor, a voltage-to-frequency converter, and a power supply modulator. The rectifier is configured to rectify the signal received from the dimmer. The voltage sensor is configured to receive a rectified signal from the rectifier and to detect a voltage of the rectified signal. The voltage-to-frequency converter is configured to receive a rectified voltage from the voltage sensor and to convert the rectified voltage to a rectified frequency. The power supply modulator is configured to receive the rectified frequency from the voltage-to-frequency converter and perform the dimming curve algorithm to drive the light source with the non-linear dimming curve.

In some embodiments, the light source is a light-emitting diode (“LED”) light source.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements.

FIG. 1 is a schematic diagram showing a system for reducing temporal light artifacts (“TLA”) occurrence during light source dimming operations according to some embodiments of the present technology.

FIG. 2A is a chart showing an example exponential dimming curve for 50% dimming generated by the system of FIG. 1. The dashed curve indicates a traditional linear curve, and the solid curve indicates the exponential dimming curve of the present technology without any detectable TLAs.

FIG. 2B is a chart showing an example exponential dimming curve for 5% dimming generated by the system of FIG. 1. The dashed curve indicates a traditional linear curve, and the solid curve indicates the exponential dimming curve of the present technology without any detectable TLAs.

FIG. 2C is a chart showing an example exponential dimming curve for 1% dimming generated by the system of FIG. 1. The dashed curve indicates a traditional linear curve, and the solid curve indicates the exponential dimming curve of the present technology without any detectable TLAs.

FIG. 3 is a chart showing example non-linear dimming curves for 5% dimming generated by the system of FIG. 1. The dashed curve indicates a traditional linear curve. The thick solid curve indicates the exponential dimming curve of the present technology, the thin solid curve indicates the cosine dimming curve of the present technology, and the dashed and dotted cure indicates the cycloid dimming curve of the present technology, all having significantly reduced or eliminated TLAs.

### DETAILED DESCRIPTION

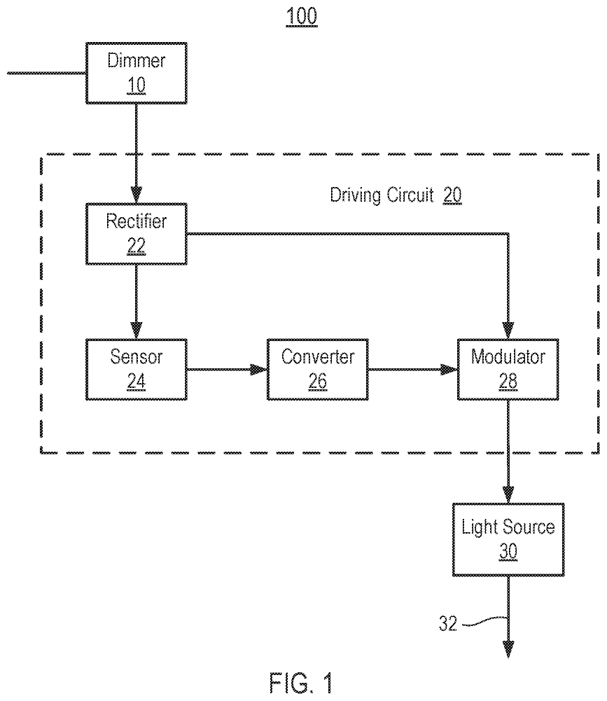

As shown in FIGS. 1, a system for reducing temporal light artifacts (“TLAs”) occurrence during light source dimming operations is generally designated by the numeral 100. The system 100 includes a dimmer 10, a driving circuit 20, and a light source 30. The dimmer 10 is configured to send a signal to the driving circuit 20. The driving circuit 20 is configured to perform a dimming curve algorithm on the signal and drive the light source 30 with a non-linear dimming curve such that a light output 32 of the light source 30 over a dimming duration has no TLAs that are detectable by the visual system of a human observing the light output 32. In some embodiments, the light source 30 is a light-emitting diode (“LED”) light source.

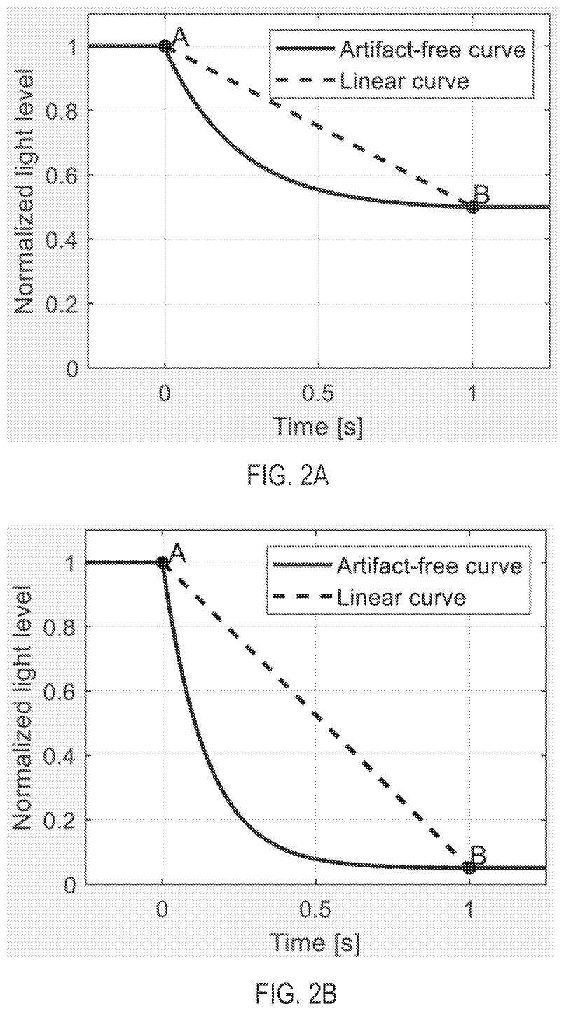

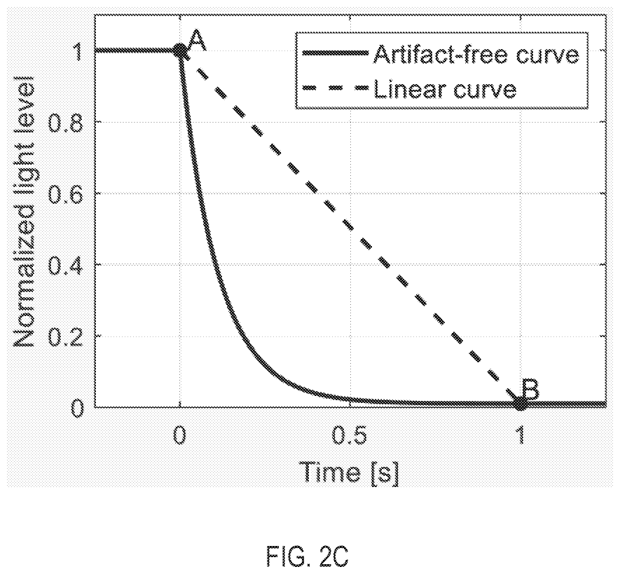

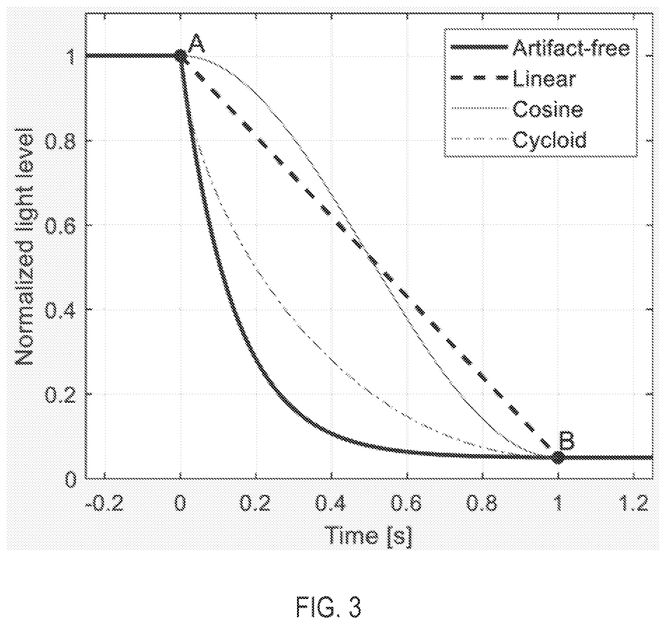

In some embodiments, the non-linear dimming curve has an irregular transition (i.e., not smooth) at a starting point A and a smooth transition at an ending point B of the dimming curve, as shown in FIGS. 2A-2C. In some embodiments, the non-linear dimming curve is an exponential curve, and the dimming duration is about 1 second or less. In some embodiments, the non-linear dimming curve is a cycloid curve, and the dimming duration is about 1 second or less, as shown in FIG. 3. In some embodiments, the non-linear dimming curve has a smooth transition at the starting point A and a smooth transition at the ending point B of the dimming curve. For example, FIG. 3 shows a cosine dimming curve that has smooth transitions at points A and B over a dimming duration of about 1 second or less. However, the present technology is not limited thereto and contemplates embodiments in which the non-linear dimming curve is a different shape and has different dimming durations, such as about 2 seconds or less, about 3 second or less, in the range of about 0.5 seconds to about 1.5 seconds, etc., provided that the non-linear dimming curve has a smooth transition at the ending point B.

As discussed in more detail below, in some embodiments, the dimming curve algorithm determines a maximum rate of change of the dimming curve. The maximum rate of change is based, at least in part, on a modulation threshold of the signal received from the dimmer 10. In some embodiments, the dimmer curve algorithm determines a relative rate of change of the dimmer curve. The relative rate of change is based, at least in part, on a minimum dim level of the light source 30. In some embodiments, the dimming curve algorithm determines a minimal detectable rate of change (i.e., a threshold at which the visual system of a human observer can detect a TLA, also referred to herein as a threshold of detection). The minimal detectable rate of change is based, at least in part, on the maximum rate of change of the dimming curve and the relative rate of change of the dimming curve. In some embodiments, the dimming curve algorithm calculates an instantaneous rate of change of the dimming curve at the ending point B of the dimming curve. Preferably, the instantaneous rate of change is less than the minimal detectable rate of change to generate an artifact-free dimming curve with a smooth transition at the ending point B of the dimming curve.

In some embodiments, the driving circuit 20 includes a rectifier 22 that is configured to rectify the signal output by the dimmer 10. The rectifier 22 can be any type of rectifier used in the art, such as a bridge rectifier, full wave rectifier, half wave rectifier, controlled rectifier, uncontrolled rectifier, etc. In some embodiments, the driving circuit 20 includes a voltage sensor 24 that is configured to receive a rectified signal output by the rectifier 22 and to detect a voltage of the rectified signal. In some embodiments, the driving circuit 20 includes a voltage-to-frequency converter 26 that is configured to receive a rectified voltage output by the voltage sensor 24 and to convert the rectified voltage to a rectified frequency. In some embodiments, the driving circuit 20 includes a power supply modulator 28 that is configured to receive the rectified frequency output by the voltage-to-frequency converter 26 and to perform the dimming curve algorithm discussed herein to drive the light source 30 with the non-linear dimming curve. In some embodiments, the power supply modulator 38 drives the light source 30 with the non-linear dimming curve by any modulation method used in the art, such as pulse with modulation, amplitude modulation, etc. The driving circuit 20 can be integrated with the light source 30 or separate from and in electrical, wired or wireless, communication with the light source 30. The dimmer 10 can be integrated with the driving circuit 20 and/or the light source 30 or separate from and in electrical, wires or wireless, communication with the driving circuit 20 and/or the light source 30. The dimmer 10 can be any dimmer used in the art, such as a digital addressable light interface dimmer, analogue control dimmer, retractive switch dimmer, corridor function dimmer, digital multiplex dimmer, phase-cutting dimmer, etc.

As used herein, dimming is described as moving from a starting point, point A, to an ending point, point B, on a Cartesian graph of light output versus time, as shown in FIGS. 2A-3. A traditional dimming curve is a straight line (i.e., a linear curve) connecting point A and point B. While seemingly smooth, the discontinuity at point B (i.e., an irregular transition) contains a continuum of spectral power that is detected by the visual system of a human observer as a TLA. Observers describe this TLA as a bump or flash of increased brightness near point B. Thus, embodiments of the present technology are directed to reducing and/or eliminating this TLA by reducing the spectral power of the transition near point B to levels below the detection limit of the human visual system. In some embodiments, eliminating this TLA results in a smooth transition at point B, as shown in the non-linear dimming curves of FIGS. 2A-3. In some embodiments, the transition near point A is irregular, as shown for example in the exponential and cycloid dimming curves of FIGS. 2A-3. However, this irregular transition at point A does not cause undesirable TLAs to human observers. In some embodiments, the transition near point A is smooth, as shown for example in the cosine dimming curve of FIG. 3.

In some embodiments, since the sensitivity of the human visual system varies with frequency, the system 100 is configured to limit the spectral power of the light source 30 over the frequency range from about 3 Hz to about 70 Hz thereby leaving frequencies below this range available for achieving the smooth transition at point B described above. In some embodiments, the dimming curve algorithm includes an exponential function that is used to generate a dimming curve that has constant relative change and achieves the smooth transition at point B:

$$y ( t ) = exp ( - at ) - b \qquad ( 1 )$$

where a is the instantaneous rate of change of the dimming curve. In some embodiments, at point B (i.e., the transition from dimming to steady state), the instantaneous rate of change is less than what is detectable by the human visual system to generate the TLA-free dimming curve. The modulation threshold, MTH, for periodic sinewave signals is about 0.5% at 10 Hz and increases to about 1% at 2 Hz. Converting the modulation threshold to a maximum rate of change by differentiating a sinewave yields a slope of −2πfM_{TH}=−0.02π. In some embodiments, the relative rate of change, r, of the exponential dimming curve is:

$$r = \frac{- a exp ( - a )}{{y}_{min}} \qquad ( 2 )$$

In some embodiments, to achieve artifact-free dimming, the relative rate of change of the dimming curve is less than the minimal detectable rate of change that causes flicker (e.g., TLAs). The threshold of detection is determined by the following equation:

$$\frac{- a exp ( - a )}{{y}_{min}} = - 2 π {fM}_{TH} = - 0.02 π \qquad ( 3 )$$

where yₘᵢₙ is the minimum dim level of the light source 30. This equation is a Lambert W function that has two real-valued solutions. In some embodiments, the W₋₁ branch provides the solution used to generate an artifact-free dimming curve. As an example, for a minimum dim level of 0.05 the solution is:

$$a = - {W}_{- 1} ( - 0.02 π {y}_{min} ) = 7.02 \qquad ( 4 )$$

The parameter b is then equal to:

$$b = exp ( - {aT}_{d} ) \qquad ( 5 )$$

where T_{d} is the duration of the dimming curve. Then, y(t) is scaled to range from 1 (representing full light output from the light source 30) to yₘᵢₙ.

$${y}_{D} ( t ) = ( 1 - {y}_{min} ) y ( t ) + {y}_{min} \qquad ( 6 )$$

In some embodiments, other non-linear dimming curve shapes that smooth the transition from dimming to steady state (i.e., smooth transition at point B) are used to reduce or eliminate TLAs. For example, FIG. 3 shows a cycloid dimming curve that has a smooth transition at point B and an irregular transition at point A, and a cosine dimming curve that has smooth transitions at both point A and point B. In some embodiments, the system 100 generates a linear dimming curve and a low-pass filter is used to reduce TLAs.

Accordingly, embodiments of the present technology are directed to systems and methods of TLA-free dimming control of LED lighting sources. The TLA-free dimming curves discussed herein can be implemented in digitally controlled lighting equipment, such as system 100, to provide smooth, flicker-free dimming between any two light output levels, provided that the dimming duration is sufficient to provide the perception of a ramp, such as dimming durations of about 1 second or less. The TLA-free dimming curves can be incorporated into the circuitry of LED drivers or LED driver chips, such as driving circuit 20, to ensure artifact-free transitions from one light output level to another light output level.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the technology.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about.” The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the technology encompasses not only the entire group listed as a whole, but each member of the group individually and all possible subgroups of the main group. Additionally, for all purposes, the technology encompasses not only the main group, but also the main group absent one or more of the group members. The technology therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A system for reducing temporal light artifacts (“TLAs”) occurrence during light source dimming operations, the system comprising:
a dimmer;
a light source; and
a driving circuit configured to receive a signal from the dimmer and perform a dimming curve algorithm on the signal to drive the light source with a non-linear dimming curve such that a light output of the light source over a dimming duration has no TLAs detectable by a human observing the light output.

2. The system of claim 1, wherein the non-linear dimming curve has an irregular transition at a starting point of the curve and a smooth transition at an ending point of the curve.

3. The system of claim 2, wherein the non-linear dimming curve is an exponential curve, and the dimming duration is about 1 second or less.

4. The system of claim 2, wherein the non-linear dimming curve is a cycloid curve, and the dimming duration is about 1 second or less.

5. The system of claim 1, wherein the non-linear dimming curve has a smooth transition at a starting point of the curve and a smooth transition at an ending point of the curve.

6. The system of claim 5, wherein the non-linear dimming curve is a cosine curve, and the dimming duration is about 1 second or less.

7. The system of claim 1, wherein performing the dimming curve algorithm comprises:
determining a maximum rate of change of the dimming curve based, at least in part, on a modulation threshold of the signal;
determining a relative rate of change of the dimming curve based, at least in part, on a minimum dim level of the light source;
determining a minimal detectable rate of change based, at least in part, on the maximum rate of change and the relative rate of change of the dimming curve; and
calculating an instantaneous rate of change of the dimming curve at an ending point of the curve such that the instantaneous rate of change is less than the minimal detectable rate of change.

8. The system of claim 7, wherein calculating the instantaneous rate of change comprises solving the W₋₁ branch of a Lambert W function equation.

9. The system of claim 1, wherein the driving circuit comprises:
a rectifier configured to rectify the signal received from the dimmer;
a voltage sensor configured to receive a rectified signal from the rectifier and to detect a voltage of the rectified signal;
a voltage-to-frequency converter configured to receive a rectified voltage from the voltage sensor and to convert the rectified voltage to a rectified frequency; and
a power supply modulator configured to receive the rectified frequency from the voltage-to-frequency converter and perform the dimming curve algorithm to drive the light source with the non-linear dimming curve.

10. The system of claim 1, wherein the light source is a light-emitting diode (“LED”) light source.

11. A method for reducing temporal light artifacts (“TLAs”) occurrence during light source dimming operations, the method comprising:
receiving, at a driving circuit, a signal from a dimmer;
performing a dimming curve algorithm on the signal to generate a non-linear dimming curve; and
driving, via the driving circuit, a light source with the non-linear dimming curve to dim a light output of the light source such that the light output over a dimming duration has no TLAs detectable by a human observing the light output.

12. The method of claim 11, wherein the non-linear dimming curve has an irregular transition at a starting point of the curve and a smooth transition at an ending point of the curve.

13. The method of claim 12, wherein the non-linear dimming curve is an exponential curve, and the dimming duration is about 1 second or less.

14. The method of claim 12, wherein the non-linear dimming curve is a cycloid curve, and the dimming duration is about 1 second or less.

15. The method of claim 11, wherein the non-linear dimming curve has a smooth transition at a starting point of the curve and a smooth transition at an ending point of the curve.

16. The method of claim 15, wherein the non-linear dimming curve is a cosine curve, and the dimming duration is about 1 second or less.

17. The method of claim 11, wherein performing the dimming curve algorithm comprises:
determining a maximum rate of change of the dimming curve based, at least in part, on a modulation threshold of the signal;
determining a relative rate of change of the dimming curve based, at least in part, on a minimum dim level of the light source;
determining a minimal detectable rate of change based, at least in part, on the maximum rate of change and the relative rate of change of the dimming curve; and
calculating an instantaneous rate of change of the dimming curve at an ending point of the curve such that the instantaneous rate of change is less than the minimal detectable rate of change.

18. The method of claim 17, wherein calculating the instantaneous rate of change comprises solving the W₋₁ branch of a Lambert W function equation.

19. The method of claim 11, wherein the driving circuit comprises:
a rectifier configured to rectify the signal received from the dimmer;
a voltage sensor configured to receive a rectified signal from the rectifier and to detect a voltage of the rectified signal;
a voltage-to-frequency converter configured to receive a rectified voltage from the voltage sensor and to convert the rectified voltage to a rectified frequency; and
a power supply modulator configured to receive the rectified frequency from the voltage-to-frequency converter and perform the dimming curve algorithm to drive the light source with the non-linear dimming curve.

20. The method of claim 11, wherein the light source is a light-emitting diode (“LED”) light source.
